(19) United States
(12) Patent Application Publication
(10) Pub. No.: US 2022/0113932 A1
(43) Pub. Date: Apr. 14, 2022

(54) INFORMATION PROCESSING DEVICE CONTROLLING SOUND ACCORDING TO SIMULTANEOUS ACTIONS OF TWO USERS

(71) Applicant: SONY GROUP CORPORATION, TOKYO (JP)

(72) Inventors: RYU AOYAMA, TOKYO (JP); IZUMI YAGI, TOKYO (JP); YOJI HIROSE, TOKYO (JP); KEI TAKAHASHI, TOKYO (JP); TAKAMOTO TSUDA, TOKYO (JP)

(21) Appl. No.: 17/431,215

(22) PCT Filed: Jan. 17, 2020
(86) PCT No.: PCT/JP2020/001554

§ 371 Date: Aug. 16, 2021

(30) Foreign Application Priority Data
Feb. 25, 2019 (JP) 2019-031908

(51) Int. Cl. G06F 3/16; G06F 3/01; G06F 1/16; G09B 19/00

(52) U.S. Cl. CPC G06F 3/165; G06F 3/011; G09B 19/0015; G06F 1/163; G06F 3/017

(57) ABSTRACT

An information processing device includes an action determining section configured to determine, on the basis of a sensing result of a sensor, an action performed by a user, a communicating section configured to receive information regarding an action performed by another user, a synchronization determining section configured to determine temporal coincidence between the action performed by the user and the action performed by the other user, and a sound control section configured to control, on the basis of the determination of the synchronization determining section, sound presented in correspondence with the actions respectively performed by the user and the other user.

### TECHNICAL FIELD

The present disclosure relates to an information processing device and an information processing method.

### BACKGROUND ART

In recent years, various sensors have been included in information processing devices. For example, a gyro sensor or an acceleration sensor is included in an information processing device in order to detect a gesture or an action of a user.

PTL 1 below discloses an information processing device that enables an operation to be performed on the basis of a gesture by including a gyro sensor or an acceleration sensor.

### CITATION LIST

### Patent Literature

[PTL 1]

Japanese Patent Laid-Open No. 2017-207890

### SUMMARY

### Technical Problem

The information processing device disclosed in PTL 1 can detect various gestures or actions of a user. In addition, the information processing device disclosed in PTL 1 has a communicating function. Hence, there is a possibility of being able to construct a new interactive entertainment using the gestures or the actions of a plurality of users by further investigating such an information processing device.

### Solution to Problem

According to the present disclosure, there is provided an information processing device including an action determining section configured to determine, on the basis of a sensing result of a sensor, an action performed by a user, a communicating section configured to receive information regarding an action performed by another user, a synchronization determining section configured to determine temporal coincidence between the action performed by the user and the action performed by the other user, and a sound control section configured to control, on the basis of the determination of the synchronization determining section, sound presented in correspondence with the actions respectively performed by the user and the other user.

In addition, according to the present disclosure, there is provided an information processing method including, by an arithmetic processing device, determining, on the basis of a sensing result of a sensor, an action performed by a user, receiving information regarding an action performed by another user, determining temporal coincidence between the action performed by the user and the action performed by the other user, and controlling, on the basis of the determination, sound presented in correspondence with the actions respectively performed by the user and the other user.

### Advantageous Effect of Invention

As described above, according to the technology according to the present disclosure, it is possible to construct a new interactive entertainment using the gestures or the actions of a plurality of users.

### BRIEF DESCRIPTION OF DRAWINGS

FIG. 1 is a diagram of assistance in explaining an example of an information processing system according to one embodiment of the present disclosure.

FIG. 2A is a diagram of assistance in explaining an example of a sensor for detecting an action of a user.

FIG. 2B is a diagram of assistance in explaining an example of sensors for detecting an action of a user.

FIG. 2C is a diagram of assistance in explaining an example of a sensor for detecting an action of a user.

FIG. 3 is a diagram of assistance in explaining information exchange in the information processing system illustrated in FIG. 1.

FIG. 4 is a block diagram illustrating an example of a configuration of the information processing system according to one embodiment of the present disclosure.

FIG. 5 is a graph diagram illustrating sensor outputs obtained by detecting actions of a user A and a user B and a sound output presented to the user B in parallel with each other.

FIG. 6 is a graph diagram illustrating an example of sound waveforms controlled by a sound control section for each combination of a user and another user.

FIG. 7A is a graph diagram illustrating sensor outputs obtained by detecting the actions of the user A and the user B and a sound output presented to the user A in parallel with each other.

FIG. 7B is a graph diagram illustrating sensor outputs obtained by detecting the actions of the user A and the user B and a sound output presented to the user A in parallel with each other.

FIG. 8 is a graph diagram illustrating an example of sensing results of actions of a user and another user as a teacher.

FIG. 9 is a diagram of assistance in explaining a method of controlling sound presented to the user on the basis of a difference between the actions of the user and the other user.

FIG. 10A is a diagram of assistance in explaining a concrete method of controlling the sound presented to the user on the basis of a difference between the actions of the user and the other user.

FIG. 10B is a diagram of assistance in explaining a concrete method of controlling the sound presented to the user on the basis of the difference between the actions of the user and the other user.

FIG. 11 is a flowchart diagram of assistance in explaining an example of a flow of operation of the information processing system according to one embodiment of the present disclosure.

FIG. 12 is a flowchart diagram of assistance in explaining an example of a flow of operation of the information processing system according to one embodiment of the present disclosure.

FIG. 13 is a flowchart diagram of assistance in explaining an example of a flow of operation of the information processing system according to one embodiment of the present disclosure.

FIG. 14 is a diagram of assistance in explaining a period in which the information processing system according to one embodiment of the present disclosure determines synchronization between users.

FIG. 15 is a diagram of assistance in explaining a modification of the information processing system according to one embodiment of the present disclosure.

FIG. 16 is a block diagram illustrating an example of hardware of an information processing device constituting an information processing server or a terminal device according to one embodiment of the present disclosure.

### DESCRIPTION OF EMBODIMENTS

Preferred embodiments of the present disclosure will hereinafter be described in detail with reference to the accompanying drawings. Incidentally, in the present specification and the drawings, constituent elements having essentially identical functional configurations are identified by the same reference signs, and thereby repeated description thereof will be omitted.

Incidentally, the description will be made in the following order.

1. Outline of Technology according to Present Disclosure

2. Example of Configuration

3. Example of Operation

4. Modifications

5. Example of Hardware Configuration

<1. Outline of Technology according to Present Disclosure>

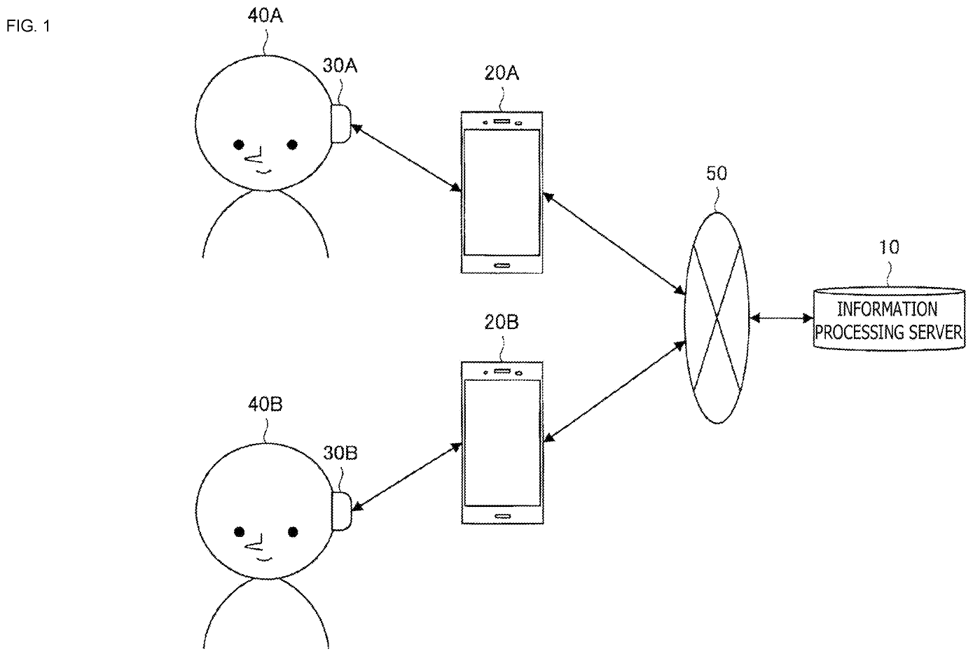

An outline of a technology according to the present disclosure will first be described with reference to FIGS. 1 to 3. FIG. 1 is a diagram of assistance in explaining an example of an information processing system according to one embodiment of the present disclosure.

As depicted in FIG. 1, the information processing system according to one embodiment of the present disclosure includes terminal devices 30A and 30B respectively carried by a plurality of users 40A and 40B, information processing devices 20A and 20B respectively carried by the plurality of users 40A and 40B, and an information processing server 10 connected to the information processing devices 20A and 20B via a network 50.

Incidentally, suppose that the terminal device 30A is carried by the same user 40A as that of the information processing device 20A, and that the terminal device 30B is carried by the same user 40B as that of the information processing device 20B. In addition, in the following, the users 40A and 40B will be collectively referred to also as users 40, the terminal devices 30A and 30B will be collectively referred to also as terminal devices 30, and the information processing devices 20A and 20B will be collectively referred to also as information processing devices 20.

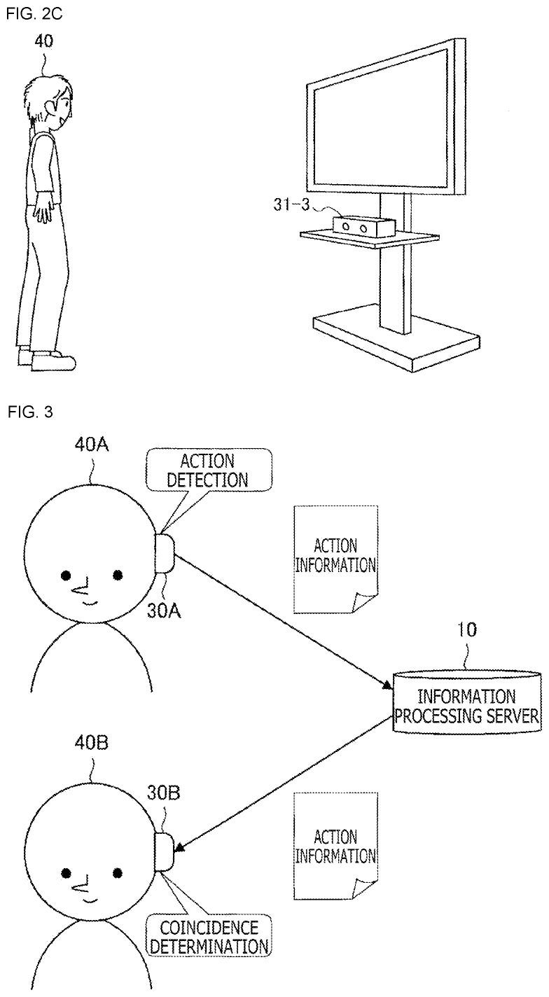

It is to be noted that, while FIG. 1 and FIG. 3 in the following illustrate only the users 40A and 40B as users 40 carrying the terminal devices 30 and the information processing devices 20, the number of users 40 is not particularly limited. The number of users 40 may be three or more.

The information processing system according to one embodiment of the present disclosure is a system that presents sound to a user in a terminal device 30 so as to correspond to an action of the user 40. In particular, the information processing system according to one embodiment of the present disclosure controls sound output in the terminal device 30 on the basis of whether or not an action of the user 40 is performed in temporal synchronism with an action of another user. According to this, the information processing system can impart interactivity with the other user to the action performed by the user 40 by a mode of sound presentation, and therefore realize content with higher interactivity.

The terminal device 30 is an information processing device that includes a sensor for detecting an action of the user 40 and a speaker that reproduces sound.

The terminal device 30 detects the action of the user 40 on the basis of a sensing result of the sensor and presents sound corresponding to the action of the user 40 to the user. In addition, the terminal device 30 transmits information regarding the action performed by the user 40 to the information processing device 20 and receives information regarding an action of the other user via the network 50. According to this, the terminal device 30 can impart interactivity with the user 40 to the action performed by the user 40 by changing the sound presented to the user 40 in a case where the action of the user 40 and the action of the other user temporally coincide with each other.

The terminal device 30 is, for example, a wearable terminal fitted to some part of a body of the user 40. Specifically, the terminal device 30 may be a headphone or earphone type wearable terminal fitted to an ear of the user 40, an eyeglass type wearable terminal fitted to a face of the user 40, a badge type wearable terminal fitted to a chest or the like of the user 40, or a wristwatch type wearable terminal fitted to a wrist or the like of the user 40.

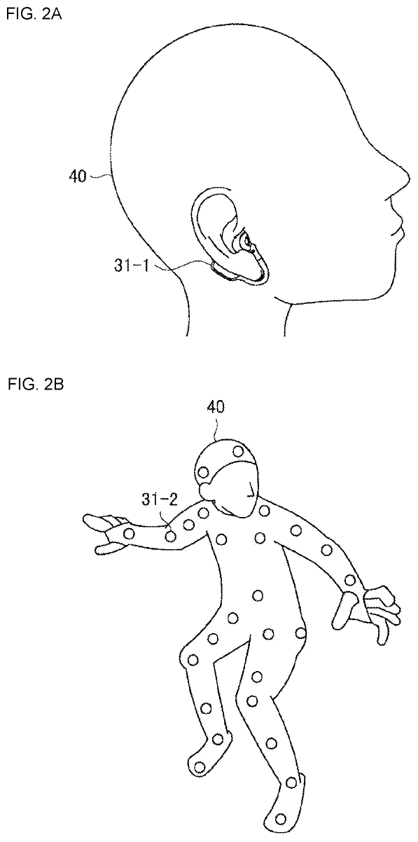

It is to be noted that the sensor provided to the terminal device 30 in order to detect the action of the user 40 is not particularly limited. An example of the sensor for detecting an action of the user 40 will be described with reference to FIGS. 2A to 2C. FIGS. 2A to 2C are diagrams of assistance in explaining an example of the sensor for detecting an action of the user.

As depicted in FIG. 2A, for example, the sensor for detecting an action of the user 40 may be a gyro sensor, an acceleration sensor, or a geomagnetic sensor provided to a headphone or an earphone 31-1 fitted to an ear of the user 40. Alternatively, as depicted in FIG. 2B, the sensor for detecting an action of the user 40 may be motion sensors 31-2 fitted to parts of the body of the user 40. Further, as depicted in FIG. 2C, the sensor for detecting an action of the user 40 may be a ToF (Time of Flight) sensor or a stereo camera 31-3 directed to the user 40.

The information processing device 20 is a communicating device that can be carried by the user 40. The information processing device 20 has a function of communicating with the terminal device 30 and a function of connecting to the network 50. The information processing device 20 receives information regarding an action of the user 40 from the terminal device 30 and transmits the information regarding the action of the user 40 to the information processing server 10. In addition, the information processing device 20 receives information regarding an action of another user from the information processing server 10 and transmits the information regarding the action of the other user to the terminal device 30. The information processing device 20 may, for example, be a smart phone, a mobile telephone, a tablet terminal, a PDA (Personal Digital Assistant), or the like.

The information processing server 10 transmits information regarding an action of the user 40 which action is detected in each of the terminal devices 30 to another terminal device 30. Specifically, the information processing server 10 transmits the information regarding to the action of the user 40 which action is detected in the terminal device 30 to the terminal device 30 of another user belonging to a same group as the user 40. For example, in a case where the users 40A and 40B belong to the same group, the information processing server 10 may transmit information regarding an action of the user 40A which action is detected in the terminal device 30A to the terminal device 30B and may transmit information regarding an action of the user 40B which action is detected in the terminal device 30B to the terminal device 30A.

The network 50 is a communication network that allows information to be transmitted and received. The network 50 may be, for example, the Internet, a satellite communication network, a telephone network, a mobile communication network (for example, a 3G or 4G network or the like), or the like.

It is to be noted that, while FIG. 1 illustrates an example in which the terminal device 30 and the information processing device 20 are provided as separate devices, the information processing system according to the present embodiment is not limited to such an illustration. For example, the terminal device 30 and the information processing device 20 may be provided as one communicating device. In such a case, the communicating device has a function of detecting the action of the user 40, a sound presenting function, and a function of connecting to the network 50, and can be configured as a communication device that can be fitted to the body of the user. In the following, description will be made supposing that the terminal device 30 also has functions of the information processing device 20.

An outline of operation of the information processing system according to one embodiment of the present disclosure will next be described with reference to FIG. 3. FIG. 3 is a diagram of assistance in explaining exchange of information in the information processing system depicted in FIG. 1.

As depicted in FIG. 3, first, in a case where the terminal device 30A detects an action of the user 40A, the terminal device 30A transmits information regarding the detected action of the user 40A as action information to the information processing server 10. Receiving the action information of the user 40A, the information processing server 10, for example, transmits the action information of the user 40A to the terminal device 30B of the user 40B belonging to the same group as the user 40A.

On the other hand, the terminal device 30B presents sound to the user 40B so as to correspond to an action of the user 40B which action is detected in the terminal device 30B. Here, the terminal device 30B determines whether the action of the user 40B is performed so as to temporally coincide with the action of the user 40A (that is, whether or not the action of the user 40B is in synchronism with the action of the user 40A), on the basis of the received action information of the user 40A. In a case where the terminal device 30B determines that the actions of the user 40A and the user 40B are performed so as to temporally coincide with each other, the terminal device 30B presents sound different from that in the case where the user 40B singly performs the action to the user 40B.

According to this, the information processing system according to one embodiment of the present disclosure can control the presented sound on the basis of whether or not the action of the user 40B and the action of the other user are synchronized with each other in content in which the sound is presented to the user 40B so as to correspond to the action of the user 40B. Hence, the information processing system can realize content with more interactivity.

In the following, the information processing system according to one embodiment of the present disclosure, the information processing system having been described in outline above, will be described more concretely.

### <2. Example of Configuration>

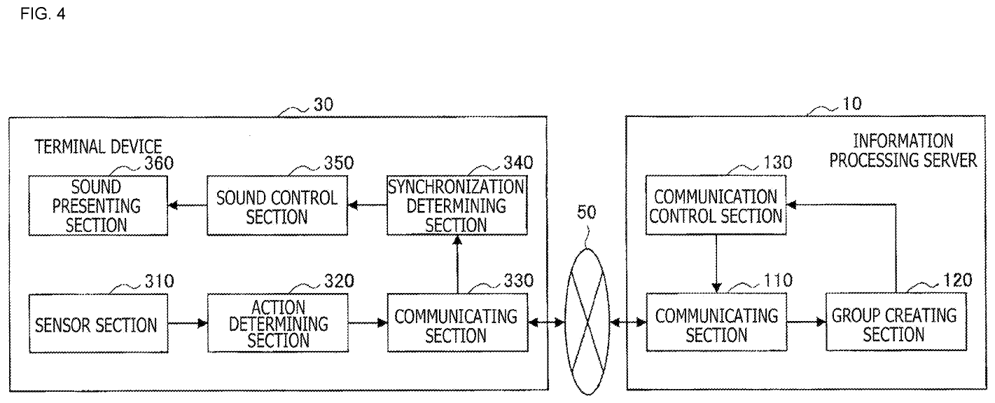

An example of a configuration of the information processing system according to one embodiment of the present disclosure will first be described with reference to FIG. 4. FIG. 4 is a block diagram illustrating an example of a configuration of the information processing system according to the present embodiment.

As depicted in FIG. 4, the information processing system according to the present embodiment includes a terminal device 30 and an information processing server 10. Specifically, the terminal device 30 includes a sensor section 310, an action determining section 320, a communicating section 330, a synchronization determining section 340, a sound control section 350, and a sound presenting section 360. The information processing server 10 includes a communicating section 110, a group creating section 120, and a communication control section 130.

Incidentally, the terminal device 30 may form a P2P (Peer to Peer) network with another terminal device 30 without the intervention of the information processing server 10.

### (Terminal Device 30)

The sensor section 310 includes a sensor for detecting an action of the user 40. Specifically, in a case where the terminal device 30 is a wearable terminal fitted to the body of the user 40, or is a mobile telephone, a smart phone, or a controller carried by the user 40, the sensor section 310 may include an acceleration sensor, a gyro sensor, or a geomagnetic sensor. In such a case, the sensor section 310 can obtain, by detecting an inclination of the terminal device 30 or a vibration applied to the terminal device 30, information for determining an action performed by the user 40.

Alternatively, the sensor section 310 may include markers and trackers for motion capture, a stereo camera, or a ToF sensor that can more directly detect the action of the user 40. In such a case, the sensor section 310 can obtain, by detecting movement of each part of the body of the user 40, information for determining the action performed by the user 40. Incidentally, the sensor section 310 may be provided on the outside of the terminal device 30 when necessary to detect the action of the user 40.

However, the sensor included in the sensor section 310 is not limited to the above-described illustration as long as the action determining section 320 in a subsequent stage can detect the action of the user 40. For example, the sensor section 310 may include a pressure sensor or a proximity sensor provided to a floor or a wall of a room in which the user 40 moves. Even in such a case, the sensor section 310 can obtain information for determining the action performed by the user 40.

In the sensor included in the sensor section 310, a threshold value for action detection or the like may be calibrated in advance. For example, in the sensor included in the sensor section 310, the threshold value for action detection may be calibrated to an appropriate value by making the user 40 perform an action to be detected in advance. Incidentally, in a case where the action to be detected is walking, walking is easily predicted from a sensing result, and therefore a parameter of action detection can be appropriately calibrated in advance.

The action determining section 320 determines, on the basis of a sensing result of the sensor section 310, the action performed by the user 40 and generates action information regarding the action of the user 40. Specifically, the action determining section 320 may determine the presence or absence of the action of the user 40 and a timing and a magnitude of the action on the basis of the sensing result of the sensor section 310 and generate the action information including the determined information. For example, in a case where the action of the user 40 is a jump, the action determining section 320 may determine a size, a direction, a start timing, and duration of the jump of the user 40 on the basis of the sensing result of the sensor section 310 and generate the action information including the determined information.

In addition, in a case where the action of the user 40 is a more complex movement, the action determining section 320 may determine the timing and the magnitude of movement of an arm, a leg, the head, or the body of the user 40 on the basis of the sensing result of the sensor section 310. In such a case, the action determining section 320 may generate information obtained by expressing the body of the user 40 as a skeleton in a form of bones as the action information. Further, the action determining section 320 may set, as the action information, the sensing result of the sensor section 310 as it is.

The communicating section 330 includes a communication interface that can connect to the network 50. The communicating section 330 transmits and receives action information to and from the information processing server 10 or another terminal device 30. Specifically, the communicating section 330 transmits the action information generated by the action determining section 320 to the information processing server 10 and receives action information of another user which action information is generated in another terminal device 30 from the information processing server 10.

The communication system of the communicating section 330 is not particularly limited as long as the communicating section 330 can transmit and receive a signal or the like to and from the network 50 in conformity with a predetermined protocol such as TCP/IP. The communicating section 330 may include a communication interface for mobile communication such as 3G, 4G, or LTE (Long Term Evolution) or for data communication and thereby be able to connect to the network 50 by these communications.

Alternatively, the communicating section 330 may be able to connect to the network 50 via another information processing device. For example, the communicating section 330 may include a communication interface for a wireless LAN (Local Area Network), Wi-Fi (registered trademark), Bluetooth (registered trademark), or WUSB (Wireless USB) and thereby be able to communicate with another information processing device by these local communications. In such a case, the information processing device that performs local communication with the terminal device 30 transmits and receives action information between the terminal device 30 and the information processing server 10 or another terminal device 30 by connecting to the network 50.

The synchronization determining section 340 determines temporal coincidence between the action performed by the user 40 and the action performed by the other user. Specifically, in a case where the user 40 performs the action, the synchronization determining section 340 compares the action information of the user 40 with the action information of the other user which action information is received in the communicating section 330, and determines whether or not timings of the actions of the user 40 and the other user coincide with each other (that is, whether or not the timings of the actions of the user 40 and the other user are in synchronism with each other).

For example, the synchronization determining section 340 may determine that the actions of the user 40 and the other user are in synchronism with each other in a case where the action of the user 40 and the action of the other user are performed within a threshold time. More specifically, the synchronization determining section 340 may determine whether or not the actions of the user 40 and the other user are in synchronism with each other by determining whether or not timings of starts or ends of the actions of the user 40 and the other user are within the threshold time. For example, in a case where the action of the user 40 is a simple action such as a jump or the like, the synchronization determining section 340 can determine whether or not the actions of the user 40 and the other user are in synchronism with each other by comparing timings in which the actions are performed (that is, the timings of the starts of the actions) with each other.

In addition, the synchronization determining section 340 may determine that the actions of the user 40 and the other user are in synchronism with each other in a case where a difference between the magnitude and the timing of a posture change at a time of the action of the user 40 and the magnitude and the timing of a posture change at a time of the action of the other user is equal to or less than a threshold value. More specifically, the synchronization determining section 340 may determine whether or not the actions of the user 40 and the other user are in synchronism with each other by determining whether or not a difference in magnitude and timing between movements of arms, legs, the heads, or the bodies in the actions performed by the user 40 and the other user is equal to or less than the threshold value. Alternatively, the synchronization determining section 340 may determine whether or not the actions of the user 40 and the other user are in synchronism with each other by determining whether or not a difference between changes in orientation of arms, legs, the heads, or the bodies in the actions performed by the user 40 and the other user is equal to or less than the threshold value. For example, in a case where the action of the user 40 is a more complex action such as a dance or the like, the synchronization determining section 340 can determine whether or not the actions of the user 40 and the other user are in synchronism with each other by comparing the magnitudes and timings of specific movements of the actions.

Further, the synchronization determining section 340 may determine whether or not the actions of the user 40 and the other user are in synchronism with each other by directly comparing the sensing result of the sensor section 310 with the sensing result of the sensor section of another terminal device 30. More specifically, the synchronization determining section 340 may determine whether or not the actions of the user 40 and the other user are in synchronism with each other by determining whether or not a difference between the magnitude and the timing of the sensing result of the action of the user 40 (that is, a raw value of output of the sensor) and the magnitude and the timing of the sensing result of the action of the other user is equal to or less than the threshold value.

It is to be noted that, while the synchronization determining section 340 may determine that the actions of the user 40 and the other user are synchronized with each other in a case where the actions of two or more users 40 are synchronized with each other, the technology according to the present disclosure is not limited to such an illustration. For example, the synchronization determining section 340 may determine that the actions of the user 40 and the other user are synchronized with each other only in a case where the actions of users 40 equal to or more than a threshold value are synchronized with each other. In addition, the synchronization determining section 340 may determine that the actions of the user 40 and the other user are synchronized with each other in a case where the actions of users 40 equal to or more than a threshold ratio within the same group are synchronized with each other.

The sound control section 350 controls the sound presenting section 360 so as to present sound to the user 40 in correspondence with the action of the user 40. For example, in a case where the action of the user 40 is a jump, the sound control section 350 may control the sound presenting section 360 so as to present a sound effect to the user 40 in respective timings of springing and landing in the jump. Alternatively, the sound control section 350 may control the sound effect presented to the user 40 on the basis of a parameter of movement of the jump such as the momentum of the springing of the jump or the like, may control the sound effect presented to the user 40 on the basis of a physical constitution of the user 40 or the like, may control the sound effect presented to the user 40 on the basis of environmental information such as the weather or the like, or may control the sound effect presented to the user 40 on the basis of a parameter of event information of content, the development of a story, or the like. Incidentally, the sound control section 350 may control the sound presenting section 360 so as to present sound to the user 40 in correspondence with the action of the other user.

The sound controlled by the sound control section 350 may be sound stored in the terminal device 30 in advance. However, the sound controlled by the sound control section 350 may be sound collected in the terminal device 30. For example, in a case where the action of the user 40 is a jump, the terminal device 30 may collect a landing sound of the user 40 making the jump and make the sound control section 350 control the collected landing sound. At this time, the sound control section 350 may use the collected sound as it is for the control, or may use sound processed by applying an effect or the like for the control.

In the information processing system according to the present embodiment, the sound control section 350 controls the sound presented to the user 40 in correspondence with the action of the user 40, on the basis of determination of the synchronization determining section 340. Specifically, the sound control section 350 may change the sound presented to the user 40 in correspondence with the action of the user 40 in a case where the synchronization determining section 340 determines that the actions of the user 40 and the other user are in synchronism with each other.

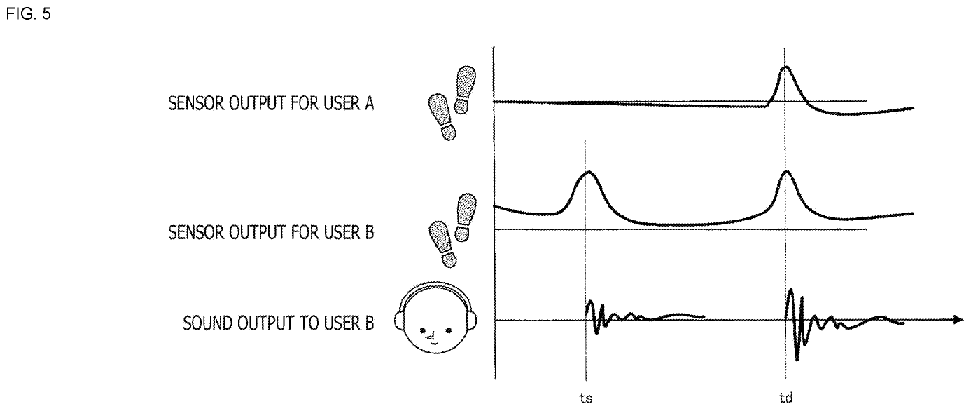

In the following, the control of sound by the sound control section 350 will be described more concretely with reference to FIGS. 5 to 7B. FIG. 5 is a graph diagram illustrating sensor outputs obtained by detecting the actions of a user A and a user B and a sound output presented to the user B in parallel with each other. In FIG. 5, the terminal device 30 outputs a sound effect in correspondence with the jumps of the users A and B.

As illustrated in FIG. 5, in a case where the sensor outputs of the users A and B take a peak, it is determined that the users A and B are jumping. At this time, the sound control section 350 may perform control such that the volume of sound output in a timing td in which the user A and the user B jump substantially simultaneously is higher than the volume of sound output in a timing ts in which only the user B jumps. In addition, in the timing td in which the user A and the user B jump substantially simultaneously and in the timing ts in which only the user B jumps, the sound control section 350 may control the duration of the sound or the height of a pitch or may control addition of a sound effect to the sound.

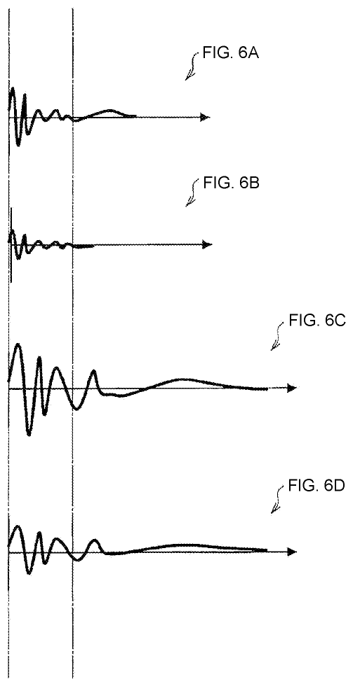

FIG. 6 is a graph diagram illustrating an example of sound waveforms controlled by the sound control section 350 for each combination of the user 40 and the other user. In FIG. 6, A illustrates an example of a sound waveform in a case where only the user 40 performs an action (for example, a jump), B illustrates an example of a sound waveform in a case where only the other user performs the action, C illustrates an example of a sound waveform in a case where the user 40 and the other user perform the action substantially simultaneously, and D illustrates an example of a sound waveform in a case where a plurality of other users performs the action substantially simultaneously.

As illustrated in FIG. 6, when a sound waveform A in the case where only the user 40 performs the action is set as a reference, a sound waveform B in the case where only the other user performs the action may be controlled to an amplitude smaller than that of the sound waveform A. In addition, the sound waveform B in the case where only the other user performs the action may be controlled such that high-frequency components are reduced, the duration of the sound waveform B is shortened, a location becomes distant, or reverb (reverberation) is applied, as compared with the sound waveform A.

On the other hand, a sound waveform C in the case where the user 40 and the other user perform the action substantially simultaneously may be controlled to an amplitude larger than that of the sound waveform A. In addition, the sound waveform C in the case where the user 40 and the other user perform the action substantially simultaneously may be controlled such that the duration of the sound waveform C is longer than that of the sound waveform A, reproduction speed is made slower, or a sound effect such as a landing sound of the jump, a rumbling of the ground, a falling sound, a cheer, or the like is added. Further, a sound waveform D in the case where the plurality of other users performs the action substantially simultaneously may be controlled to be a waveform intermediate between the sound waveform B in the case where only the other user performs the action and the sound waveform D in the case where the user 40 and the other user perform the action substantially simultaneously.

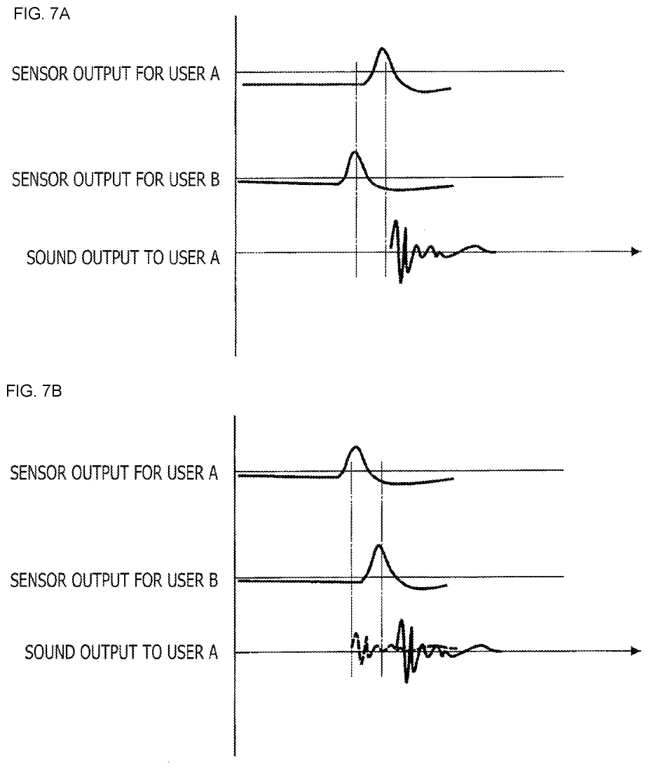

Here, in a case where the sound control section 350 controls the sound presented to the user 40 after it is confirmed that the user 40 and the other user have performed the action within a threshold time, there is a possibility that a timing of presentation of the sound is shifted from a timing of the action of the user 40. Control of the sound control section 350 in such a case will be described with reference to FIG. 7A and FIG. 7B. FIG. 7A and FIG. 7B are graph diagrams illustrating sensor outputs obtained by detecting the actions of the user A and the user B and a sound output presented to the user A in parallel with each other. In FIG. 7A and FIG. 7B, the terminal device 30 outputs a sound effect in correspondence with the jumps of the users A and B.

In a case illustrated in FIG. 7A, at a point in time that it is confirmed that the user A has performed an action (that is, a jump), it is already recognized that the other user B has performed the action within a threshold time. Therefore, the sound control section 350 can control the sound presenting section 360 such that sound in a case where the actions of a plurality of users are in synchronism with each other is presented in correspondence with the action of the user A.

On the other hand, in a case illustrated in FIG. 7B, at a point in time that it is confirmed that the user A has performed the action, whether or not the other user B has performed the action within the threshold time is not recognized. Therefore, the sound control section 350 controls the sound presenting section 360 such that sound in the case where only the user A has performed the action is first presented in correspondence with the action of the user A. Thereafter, in a case where it is recognized that the other user B has performed the action within the threshold time, the sound control section 350 controls the sound presenting section 360 such that sound in a case where the actions of a plurality of users are in synchronism with each other is presented so as to be superimposed on the sound in the case where only the user A has performed the action. According to such control, the sound control section 350 can control the sound presenting section 360 such that sound is presented in correspondence with the action of the user A before confirmation of whether or not the other user B has performed the action within the threshold time. Hence, the sound control section 350 can prevent the timing of the presentation of the sound from being shifted from the timing of the action of the user 40.

Further, in a case where the synchronization determining section 340 determines synchronization of the actions of the user 40 and the other user on the basis of a difference between the magnitudes and the timings of posture changes during the actions of the user 40 and the other user, the sound control section 350 may control the sound presented to the user 40, on the basis of the difference between the magnitudes and the timings of posture changes during the actions. Specifically, in a case where the action of the user 40 is a complex action such as a dance or the like, the sound control section 350 can present appropriateness of the movement to the user 40 by reflecting, in the sound, a difference between a posture change during the action of the other user as a teacher and a posture change during the action of the user 40.

For example, in a case where a difference between the posture change during the action of the other user as the teacher and the posture change during the action of the user 40 is small, the sound control section 350 may control the sound presenting section 360 such that sound whose volume is higher, whose duration is longer, or which has an additional sound effect added thereto is presented to the user 40. Alternatively, in a case where a difference between the posture change during the action of the other user as the teacher and the posture change during the action of the user 40 is large, the sound control section 350 may control the sound presenting section 360 such that sound whose volume is higher is presented to the user 40. Further, the sound control section 350 may compare posture changes during the actions of the plurality of other users with the posture change during the action of the user 40 and control the sound presenting section 360 such that sound whose volume is higher is presented to the user 40 in a case where a degree of coincidence between the posture changes during the actions of the user 40 and the plurality of other users is higher.

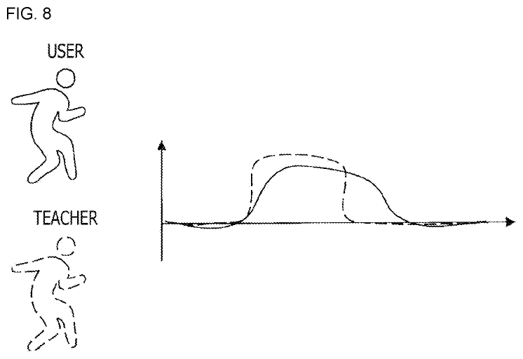

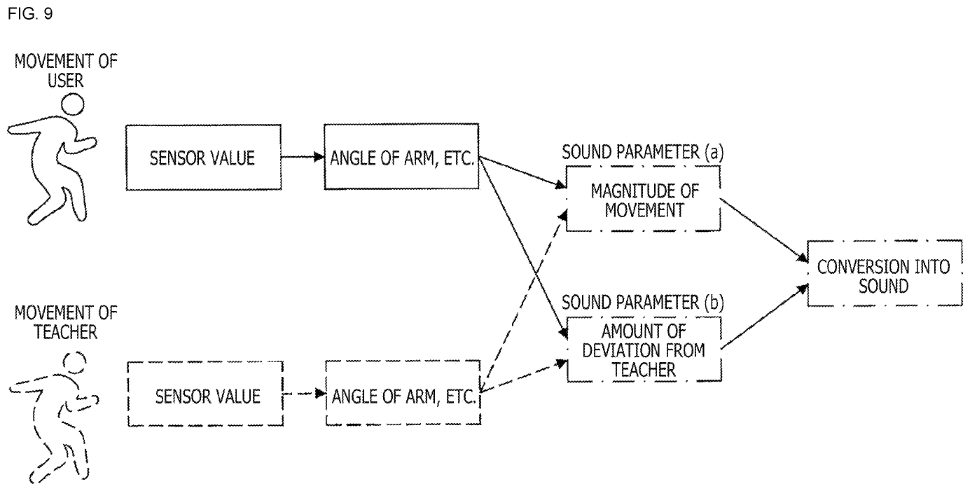

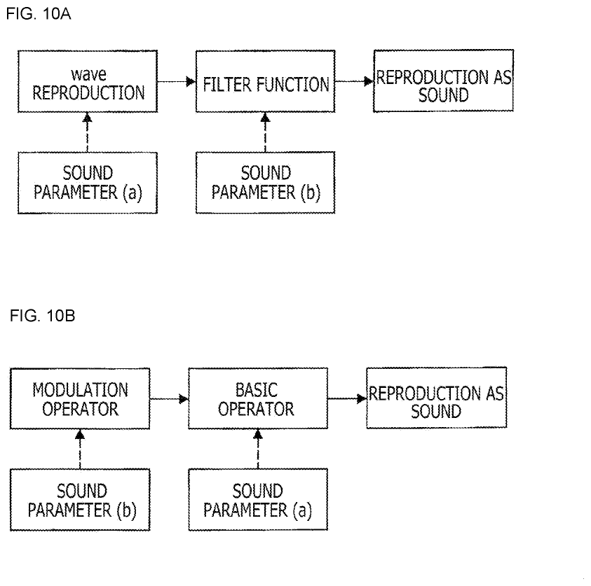

In the following, operation of such a sound control section 350 will be described more concretely with reference to FIGS. 8 to 10B. FIG. 8 is a graph diagram illustrating an example of sensing results of the actions of the user 40 and the other user as the teacher. In addition, FIG. 9 is a diagram of assistance in explaining a method of controlling the sound presented to the user 40 on the basis of a difference between the actions of the user 40 and the other user. FIG. 10A and FIG. 10B are diagrams of assistance in explaining concrete methods of controlling the sound presented to the user 40 on the basis of the difference between the actions of the user 40 and the other user. In FIG. 8 and FIG. 9, the sensing result of the action of the user 40 is indicated by a solid line, and the sensing result of the action of the other user as the teacher is indicated by a broken line.

In a case where the actions are complex actions such as a dance or the like, posture changes during the actions of the user 40 and the other user can be converted into parameter changes as illustrated in FIG. 8 by using motion sensors, motion capture, or the like. Parameters on an axis of ordinates illustrated in FIG. 8 are parameters obtained by converting the values of sensors sensing the movements of the user 40 and the other user and are, for example, parameters of angles of arms of the user 40 and the other user. The sound control section 350 can control the sound presented to the user 40, on the basis of a difference between the movements of the user 40 and the other user in a time in which either the user 40 or the other user moves. According to this, the sound control section 350 can continuously control the sound presented to the user 40.

Specifically, as illustrated in FIG. 9, the sound control section 350 compares, between the user 40 and the other user, the parameters of the angles of the arms or the like which parameters are converted from the values of the sensors detecting the actions of the user 40 and the other user. The sound control section 350 can thereby detect, between the actions of the user 40 and the other user, an amount of deviation and a magnitude difference in posture change during the actions. The sound control section 350 can control the sound presented to the user 40 by using the detected magnitude difference in posture change during the actions (sound parameter a) and the detected amount of deviation in posture change during the actions (sound parameter b) as sound modulation parameters.

For example, as illustrated in FIG. 10A, in a case where the sound presented to the user 40 is a loop of a sound waveform stored in advance, the sound control section 350 may use the magnitude difference in posture change during the actions (sound parameter a) as a parameter for controlling the amplitude of the sound waveform. In addition, the sound control section 350 may use the amount of deviation between the actions (sound parameter b) as a parameter for controlling a filter function made to act on the sound waveform.

In addition, as illustrated in FIG. 10B, in a case where the sound presented to the user 40 is from an FM (Frequency Modulation) sound source, the sound control section 350 may use the magnitude difference in posture change during the actions (sound parameter a) as a parameter for controlling a frequency and an amplitude of the FM sound source. In addition, the sound control section 350 may use the amount of deviation between the actions (sound parameter b) as a parameter for controlling an intensity of FM modulation of the FM sound source. According to this, the sound control section 350 can control the sound presenting section 360 such that sound with a soft tone is presented in a case where an amount of deviation between the actions of the user 40 and the other user is small and such that sound with a hard tone is presented in a case where an amount of deviation between the actions of the user 40 and the other user is large.

Incidentally, it is considered that, in a case where the user 40 performs the action after recognizing the action of the other user as the teacher, the user 40 moves after the other user as the teacher moves first. Therefore, in a case where the timing of the action of the user 40 is later than the timing of the action of the other user as the teacher, the sound control section 350 may assume the amount of deviation between the actions (sound parameter b) to be zero. On the other hand, in a case where the timing of the action of the user 40 is earlier than the timing of the action of the other user as the teacher, the sound control section 350 may reflect the amount of deviation between the actions (sound parameter b) as it is as a sound modulation parameter.

The sound presenting section 360 includes a sound output device such as a speaker or a headphone. The sound presenting section 360 presents sound to the user 40. Specifically, the sound presenting section 360 may convert an audio signal of audio data controlled in the sound control section 350 into an analog signal and output the analog signal as sound.

Incidentally, in a case where the actions of a plurality of users are in synchronism with each other, the terminal device 30 may present further output to the user 40. For example, in a case where the actions of the plurality of users are in synchronism with each other, the terminal device 30 may control a display unit so as to display a predetermined image. In addition, in the case where the actions of the plurality of users are in synchronism with each other, the terminal device 30 may control content such that story development of the content changes.

### (Information Processing Server 10)

The communicating section 110 includes a communication interface that can connect to the network 50. The communicating section 110 transmits and receives action information to and from the terminal device 30. Specifically, the communicating section 110 transmits action information transmitted from the terminal device 30 to another terminal device 30.

The communication system of the communicating section 110 is not particularly limited as long as the communicating section 110 can transmit and receive a signal or the like to and from the network 50 in conformity with a predetermined protocol such as TCP/IP. The communicating section 110 may include a communication interface for mobile communication such as 3G, 4G, or LTE (Long Term Evolution) or for data communication and thereby be able to connect to the network 50.

The communication control section 130 controls to which terminal device 30 to transmit the received action information. Specifically, the communication control section 130 controls the communicating section 110 so as to transmit the action information to the terminal device 30 of a user belonging to the same group as the user 40 corresponding to the received action information. According to this, the terminal device 30 can determine temporal coincidence of the action of the user 40 belonging to the same group. Incidentally, the group to which the user 40 belongs is created in the group creating section 120 to be described later.

The group creating section 120 creates, in advance, the group of the user 40 in which group action information is mutually transmitted and received. Specifically, the group creating section 120 may create the group of the user 40 in which action information is mutually transmitted and received, by grouping users who are present in a same region, experience same content, use a same application, or use a same device.

For example, the group creating section 120 may group users 40 experiencing same content simultaneously into the same group in advance. In addition, the group creating section 120 may group users 40 using a dedicated device or a dedicated application into the same group. Further, the group creating section 120 may group users 40 experiencing same content via the network 50 into the same group.

For example, the group creating section 120 may determine positions of terminal devices 30 by using position information of the GNSS (Global Navigation Satellite System) of the terminal devices 30 or the like, network information of a mobile communication network such as 3G, 4G, LTE, or 5G, a beacon, or the like, and group users 40 present in a same region into the same group. In addition, the group creating section 120 may group users 40 present in a same region according to virtual position information within a virtual space into the same group. Further, the group creating section 120 may group users 40 present in a same region who are found by P2P communication between terminal devices 30 into the same group.

Alternatively, the group creating section 120 may group users 40 who performed a same gesture within a predetermined time into the same group, may group users 40 who detected same sound into the same group, or may group users 40 who photographed a same subject (for example, a specific identification image of a two-dimensional code or the like) into the same group.

Further, the group creating section 120 may group users 40 in advance by using friend relation that can be detected from an SNS (Social Networking Service). In such a case, the group creating section 120 may automatically create a group by obtaining account information of the users 40 in the SNS. Incidentally, in a case where the group creating section 120 has automatically created the group, the group creating section 120 may present the group to which the users 40 belong to the terminal devices 30 carried by the users 40 by sound or an image.

### <3. Example of Operation>

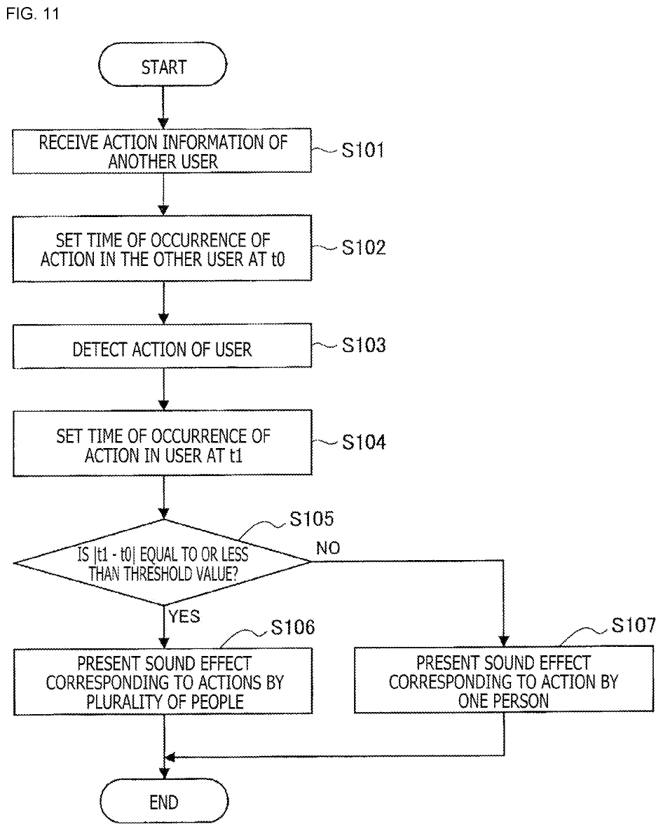

An example of operation of the information processing system according to one embodiment of the present disclosure will next be described with reference to FIGS. 11 to 13. FIGS. 11 to 13 are flowchart diagrams of assistance in explaining an example of flows of operation of the information processing system according to one embodiment of the present disclosure.

### (First Example of Operation)

A flow of operation illustrated in FIG. 11 is an example of operation in a case where action information of the other user is received before action information of the user 40 is detected.

As illustrated in FIG. 11, first, the communicating section 330 receives the action information of the other user from the information processing server 10 (S101), and the synchronization determining section 340 sets a time of occurrence of the action of the other user at t0 (S102). Thereafter, the action determining section 320 detects the action of the user 40 on the basis of a sensing result of the sensor section 310 (S103), and the synchronization determining section 340 sets a time of occurrence of the action of the user 40 at t1 (S104).

Here, the synchronization determining section 340 determines whether or not |t1-t0| (absolute value of a difference between t1 and t0) is equal to or less than a threshold value (S105). In a case where |t1-t0| is equal to or less than the threshold value (S105/Yes), the sound control section 350 controls the sound presenting section 360 so as to present, to the user 40, a sound effect corresponding to a case where the actions of a plurality of people are synchronized with each other (S106). In a case where |t1-t0| is not equal to or less than the threshold value (S105/No), on the other hand, the sound control section 350 controls the sound presenting section 360 so as to present, to the user 40, a sound effect corresponding to the action of one person (S107).

### (Second Example of Operation)

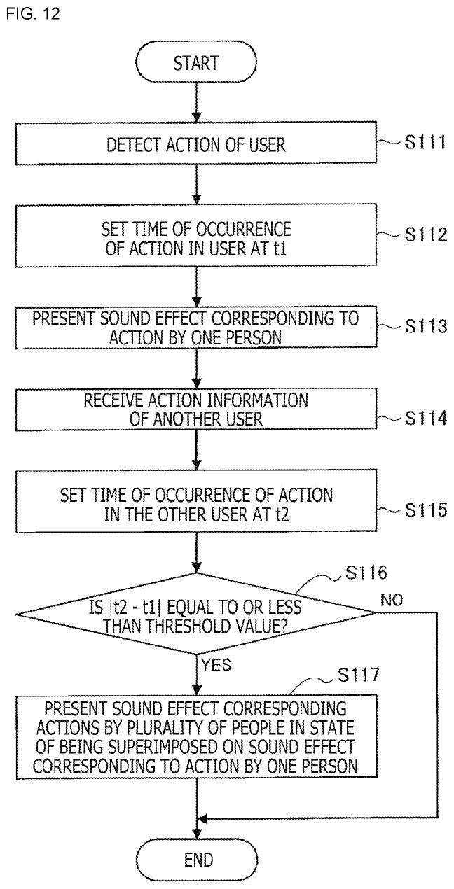

A flow of operation illustrated in FIG. 12 is an example of operation in a case where action information of the user 40 is detected before action information of the other user is received.

As illustrated in FIG. 12, first, the action determining section 320 detects the action of the user 40 on the basis of a sensing result of the sensor section 310 (S111), and the synchronization determining section 340 sets a time of occurrence of the action of the user 40 at t1 (S112). Accordingly, the sound control section 350 first controls the sound presenting section 360 so as to present, to the user 40, a sound effect corresponding to the action of one person (S113). Thereafter, the communicating section 330 receives the action information of the other user from the information processing server 10 (S114), and the synchronization determining section 340 sets a time of occurrence of the action of the other user at t2 (S115).

Here, the synchronization determining section 340 determines whether or not |t2-t1| (absolute value of a difference between t2 and t1) is equal to or less than a threshold value (S116). In a case where |t2-t1| is equal to or less than the threshold value (S116/Yes), the sound control section 350 controls the sound presenting section 360 so as to present, to the user 40, a sound effect corresponding to a case where the actions of a plurality of people are synchronized with each other in a state of being superimposed on a sound effect corresponding to the action of one person (S117). In a case where |t2-t1| is not equal to or less than the threshold value (S116/No), on the other hand, the sound control section 350 presents, to the user 40, the sound effect corresponding to the action of one person, and then ends the control of the sound presenting section 360.

### (Third Example of Operation)

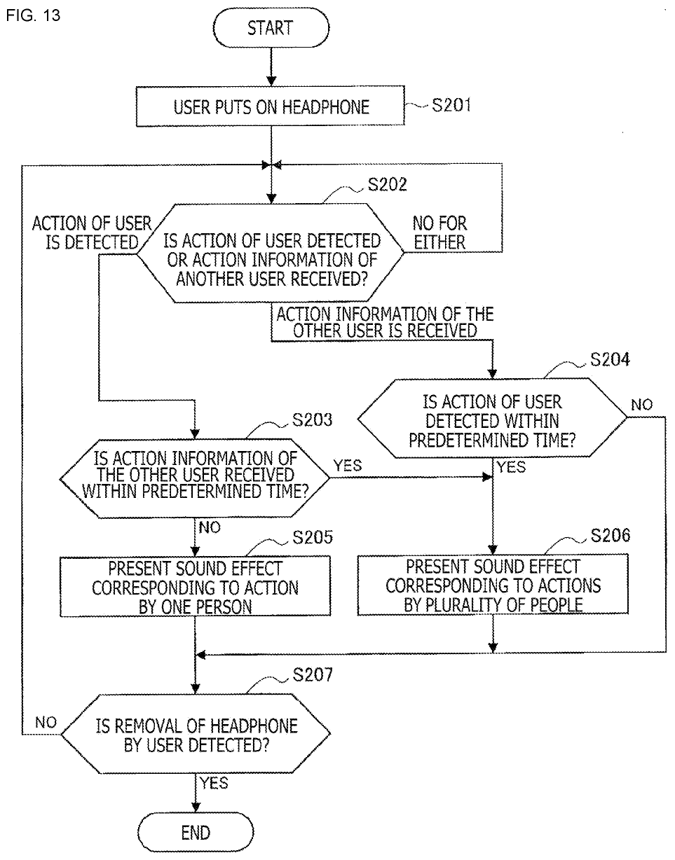

An example of operation illustrated in FIG. 13 is an example of operation not limited by the order of the detection of the action information of the user 40 and the reception of the action information of the other user.

As illustrated in FIG. 13, first, the user 40 puts on a headphone as a terminal device 30 (S201). The terminal device 30 thereby starts operation of presenting sound in correspondence with the action of the user 40. That is, the terminal device 30 determines whether or not either detection of the action of the user 40 by the action determining section 320 or reception of the action information of the other user by the communicating section 330 has occurred (S202). In a case where neither has occurred (S202/No for either), the terminal device 30 continues performing the operation of step S202.

In a case where the action of the user 40 is detected (S202/the action of the user is detected), the synchronization determining section 340 determines whether or not action information of the other user is received within a predetermined time (S203). In a case where action information of the other user is received within the predetermined time (S203/Yes), the sound control section 350 controls the sound presenting section 360 so as to present, to the user 40, a sound effect corresponding to a case where the actions of a plurality of people are synchronized with each other (S206). In a case where action information of the other user is not received within the predetermined time (S203/No), on the other hand, the sound control section 350 controls the sound presenting section 360 so as to present, to the user 40, a sound effect corresponding to the action of one person (S205).

In addition, in a case where action information of the other user is received in step S202 (S202/reception of action information of the other user), the synchronization determining section 340 determines whether or not the action of the user 40 is detected within a predetermined time (S204). In a case where the action of the user 40 is detected within the predetermined time (S204/Yes), the sound control section 350 controls the sound presenting section 360 so as to present, to the user 40, a sound effect corresponding to a case where the actions of a plurality of people are synchronized with each other (S206). In a case where the action of the user 40 is not detected within the predetermined time (S204/No), on the other hand, the sound control section 350 ends the operation without presenting any sound effect to the user 40.

Thereafter, the terminal device 30 determines whether or not removal of the headphone as the terminal device 30 by the user 40 is detected (S207) and performs the operation of step S202 until the terminal device 30 determines that the user 40 has removed the headphone (S207/Yes). In a case of determining that the user 40 has removed the headphone (S207/Yes), the terminal device 30 ends the operation of presenting sound in correspondence with the action of the user 40.

It is to be noted that, while the removal of the headphone as the terminal device 30 by the user 40 is used to end the flowchart in the third operation example, the third operation example is not limited to the above-described illustration. For example, the third operation example may be ended on the basis of ending of an application for experiencing content by the user 40, starting of another application for the telephone, message transmission and reception, or the like by the user 40, belonging of the user 40 to another group, separation of the user 40 from a predetermined region, ending of experiencing content due to the passage of a predetermined time or holding of a predetermined condition, issuance of an instruction to end by a member of the group to which the user 40 belongs, or the like.

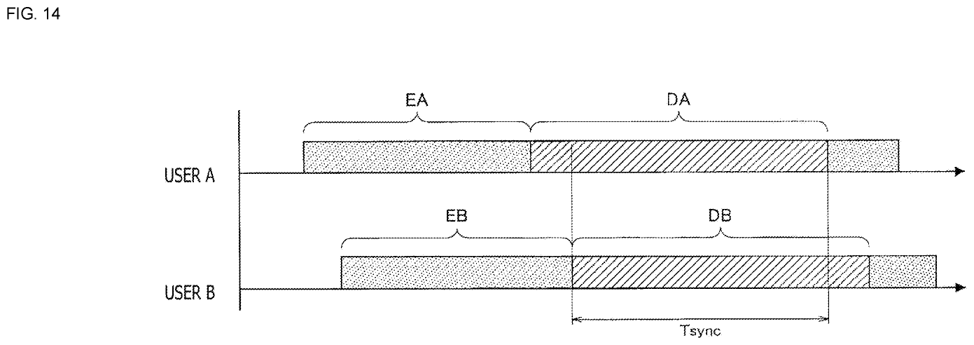

In the following, referring to FIG. 14, description will be made of a period in which the information processing system according to the present embodiment determines synchronization of the actions of the user 40 and the other user. FIG. 14 is a diagram of assistance in explaining a period in which the information processing system according to the present embodiment determines synchronization between the users.

In FIG. 14, EA indicates a period in which the user A wears a terminal device 30 as an earphone or headphone type, and DA indicates a period in which the action of the user A is detected. Similarly, EB indicates a period in which the user B wears a terminal device 30 as an earphone or headphone type, and DB indicates a period in which the action of the user B is detected.

In such a case, a period Tsync in which the information processing system according to the present embodiment determines synchronization between the users is a period in which the respective actions of the user A and the user B can be detected simultaneously. That is, the period Tsync for determining synchronization between the users is a period in which the period DA for detecting the action of the user A and the period DB for detecting the action of the user B overlap each other.

The period for detecting the action of the user 40 may be set on the basis of story development of content, or may be set by a starting operation and an ending operation on the terminal device 30 by the user 40. In addition, a start and an end of the period for detecting the action of the user 40 may be set by each of users 40 carrying the terminal devices 30, may be set collectively for the users 40 within the group on the basis of an instruction from a specific user 40 within the group, or may be set collectively for users 40 in a predetermined region on the basis of an external instruction such as a beacon.

### <4. Modifications>

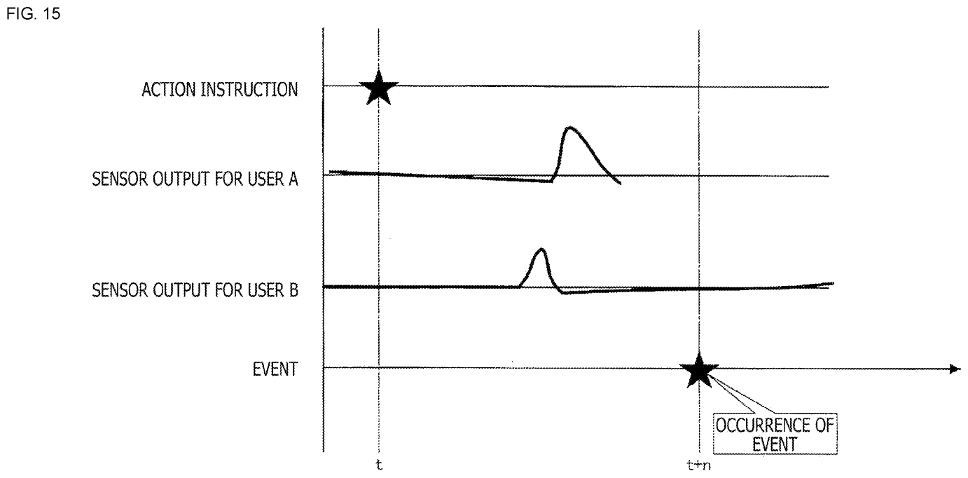

A modification of the information processing system according to the present embodiment will next be described with reference to FIG. 15. FIG. 15 is a diagram of assistance in explaining a modification of the information processing system according to the present embodiment.

A modification of the information processing system according to the present embodiment is an example in which action synchronization is realized between a plurality of users without transmission and reception of action information between the terminal devices 30 of the plurality of users.

As illustrated in FIG. 15, for example, at time t, an instruction for a predetermined action (for example, a jump or the like) is transmitted from the information processing server 10 to the terminal devices 30 carried by the users A and B. Here, in a case where the users A and B perform the specified predetermined action before time t+n, the information processing server 10 generates an event corresponding to the predetermined action at time t+n. The terminal devices 30 respectively carried by the users A and B thereby present sound corresponding to the predetermined action to the users A and B, respectively. Incidentally, in a case where either the user A or B does not perform the specified predetermined action before time t+n, the information processing server 10 cancels the generation of the event corresponding to the predetermined action.

That is, in the information processing system according to the present modification, no action information is shared between the terminal devices 30 respectively carried by the users A and B. However, by discretely managing timings in which the action is performed in the information processing server 10 for each predetermined period, it is possible to present sound in synchronism on each of the terminal devices 30 respectively carried by the users A and B. According to this, the information processing system according to the present modification can provide content with simultaneity to the plurality of users without information being shared between the terminal devices 30.

### <5. Example of Hardware Configuration>

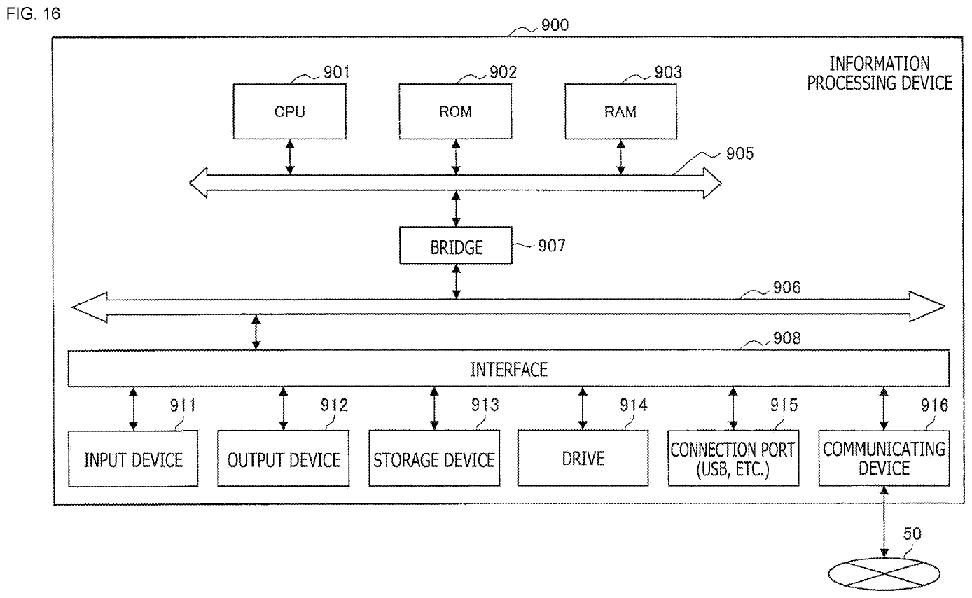

Next, referring to FIG. 16, description will be made of an example of a hardware configuration of the information processing server 10 or the terminal device 30 according to one embodiment of the present disclosure. FIG. 16 is a block diagram illustrating an example of hardware of an information processing device 900 constituting the information processing server 10 or the terminal device 30 according to one embodiment of the present disclosure. Information processing performed by the information processing server 10 or the terminal device 30 is implemented by cooperation between hardware and software to be described in the following.

As illustrated in FIG. 16, the information processing device 900 includes, for example, a CPU (Central Processing Unit) 901, a ROM (Read Only Memory) 902, a RAM (Random Access Memory) 903, a bridge 907, a host bus 905, an external bus 906, an interface 908, an input device 911, an output device 912, a storage device 913, a drive 914, a connection port 915, and a communicating device 916.

The CPU 901 functions as an arithmetic processing device and a control device and controls the whole of operation of the information processing device 900 according to a program stored in the ROM 902 or the like. The ROM 902 stores the program and operation parameters used by the CPU 901. The RAM 903 temporarily stores the program used in execution by the CPU 901 and parameters changing as appropriate in the execution or the like. The CPU 901 may, for example, function as the action determining section 320, the synchronization determining section 340, and the sound control section 350, or may function as the group creating section 120 and the communication control section 130.

The CPU 901, the ROM 902, and the RAM 903 are interconnected by the host bus 905 including a CPU bus or the like. The host bus 905 is connected to the external bus 906 such as a PCI (Peripheral Component Interconnect/Interface) bus via the bridge 907. Incidentally, the host bus 905, the bridge 907, and the external bus 906 do not necessarily need to be configured in a separated manner, but the functions of the host bus 905, the bridge 907, and the external bus 906 may be implemented in one bus.

The input device 911 includes input devices supplied with information such as various kinds of sensors, a touch panel, a keyboard, a button, a microphone, a switch, and a lever and an input control circuit for generating an input signal on the basis of input and outputting the input signal to the CPU 902. The input device 911 may, for example, function as the sensor section 310.

The output device 912 is a device capable of visually or auditorily notifying the user of information. The output device 912 may be, for example, a display device such as a CRT (Cathode Ray Tube) display device, a liquid crystal display device, a plasma display device, an EL (ElectroLuminescence) display device, a laser projector, an LED (Light Emitting Diode) projector, or a lamp, or may be a sound output device or the like such as a speaker or headphones. The output device 912 may function as the sound presenting section 360.

The storage device 913 is a device for data storage which device is configured as an example of a storage unit of the information processing device 900. The storage device 913 may be implemented by, for example, a magnetic storage device such as an HDD (Hard Disk Drive), a semiconductor storage device, an optical storage device, a magneto-optical storage device, or the like. The storage device 913 may, for example, include a storage medium, a recording device that records data on the storage medium, a readout device that reads out the data from the storage medium, a deleting device that deletes the data recorded on the storage medium, and the like. The storage device 913 may store the program executed by the CPU 901, various kinds of data, various kinds of externally obtained data, and the like.

The drive 914 is a reader/writer for a storage medium. The drive 914 reads out information stored on removable storage media such as various kinds of optical disks or semiconductor memories inserted into the drive 914 and outputs the information to the RAM 903. The drive 914 can write information to the removable storage media.

The connection port 915 is an interface connected to an external apparatus. The connection port 915 is a connection port capable of transmitting data to the external apparatus. The connection port 915 may be a USB (Universal Serial Bus), for example.

The communicating device 916 is, for example, an interface formed by a communicating device or the like for connecting to a network 920. The communicating device 916 may, for example, be a communication card or the like for a wired or wireless LAN (Local Area Network), LTE (Long Term Evolution), Bluetooth (registered trademark), or WUSB (Wireless USB). In addition, the communicating device 916 may be a router for optical communication, a router for ADSL (Asymmetric Digital Subscriber Line), modems for various kinds of communications, or the like. The communicating device 916 can, for example, transmit and receive signals or the like to and from the Internet or another communicating device in conformity with a predetermined protocol such as TCP/IP. The communicating device 916 may function as the communicating sections 110 and 330.

Incidentally, it is possible to create a computer program for making the hardware such as the CPU, the ROM, and the RAM included in the information processing device 900 exert functions similar to those of each configuration of the information processing server 10 or the terminal device 30 according to the present embodiment described above. In addition, it is possible to provide a storage medium storing the computer program.

A preferred embodiment of the present disclosure has been described above in detail with reference to the accompanying drawings. However, the technical scope of the present disclosure is not limited to such an example. It is obvious that a person having an ordinary knowledge in the technical field of the present disclosure could conceive of various changes or modifications within the scope of technical concepts described in claims. It is therefore to be understood that these changes or modifications also naturally fall within the technical scope of the present disclosure.

For example, while it is assumed in the foregoing embodiment that the terminal device 30 controls sound presentation, the technology according to the present disclosure is not limited to such an example. For example, the terminal device 30 may control vibration presentation.

In addition, effects described in the present specification are merely descriptive or illustrative and are not restrictive. That is, the technology according to the present disclosure can produce other effects obvious to those skilled in the art from the description of the present specification together with the above-described effects or in place of the above-described effects.

It is to be noted that the following configurations also belong to the technical scope of the present disclosure.
(1)

An information processing device including:

an action determining section configured to determine, on the basis of a sensing result of a sensor, an action performed by a user;

a communicating section configured to receive information regarding an action performed by another user;

a synchronization determining section configured to determine temporal coincidence between the action performed by the user and the action performed by the other user; and

a sound control section configured to control, on the basis of the determination of the synchronization determining section, sound presented in correspondence with the actions respectively performed by the user and the other user.
(2)

The information processing device according to the above (1), in which

the synchronization determining section determines that the actions of the user and the other user are in synchronism with each other in a case where the action of the user and the action of the other user are performed within a threshold time.
(3)

The information processing device according to the above (2), in which

the sound control section changes the presented sound on the basis of whether or not the actions of the user and the other user are in synchronism with each other.
(4)

The information processing device according to the above (3), in which

the sound control section controls at least one or more of duration, volume, a pitch, or added sound of the presented sound.
(5)

The information processing device according to the above (3) or (4), in which,

in a case where the actions of the user and the other user are in synchronism with each other, the sound control section controls the sound such that duration, volume, or a pitch of the presented sound is increased as compared with a case where the actions of the user and the other user are not in synchronism with each other.
(6)

The information processing device according to the above (5), in which,

in a case where it is determined that the actions of the user and the other user are in synchronism with each other after sound in a case where the actions of the user and the other user are asynchronous with each other is presented in correspondence with the action of the user, the sound control section controls the sound such that sound in a case where the actions of the user and the other user are in synchronism with each other is presented so as to be superimposed on the sound in the case where the actions of the user and the other user are asynchronous with each other.
(7)

The information processing device according to any one of the above (1) to (6), in which

the sound presented in correspondence with the action of the other user is decreased in duration, volume, or pitch of the sound as compared with the sound presented in correspondence with the action of the user.
(8)

The information processing device according to any one of the above (1) to (7), in which

the sensor is included in a wearable device worn by the user.
(9)

The information processing device according to the above (8), in which

the sound control section generates the presented sound by modulating sound collected in the wearable device.
(10)

The information processing device according to any one of the above (1) to (9), in which

the synchronization determining section determines the temporal coincidence between the action performed by the user and the action performed by the other user belonging to a same group as the user.
(11)

The information processing device according to the above (10), in which

the group is a group in which users present in a same region, experiencing same content, using a same application, or using a same device are grouped together.
(12)

The information processing device according to the above (1), in which

the synchronization determining section determines that the actions of the user and the other user are in synchronism with each other in a case where a difference between a magnitude and a timing of a posture change during the action of the user and a magnitude and a timing of a posture change during the action of the other user is equal to or less than a threshold value.
(13)

The information processing device according to the above (12), in which

the synchronization determining section determines a difference in magnitude and timing of movement of at least one or more of an arm, a leg, a head, or a body between the user and the other user.
(14)

The information processing device according to the above (12) or (13), in which

the sound control section controls a waveform of the presented sound on the basis of a difference between posture changes and timings during the actions of the user and the other user.
(15)

The information processing device according to the above (14), in which

the sound control section controls a frequency, an amplitude, or a tone of the presented sound.
(16)

The information processing device according to the above (14) or (15), in which

the sound control section continuously changes the waveform of the presented sound.
(17)

An information processing method including: by an arithmetic processing device,

determining, on the basis of a sensing result of a sensor, an action performed by a user;

receiving information regarding an action performed by another user;

determining temporal coincidence between the action performed by the user and the action performed by the other user; and

controlling, on the basis of the determination, sound presented in correspondence with the actions respectively performed by the user and the other user.

### REFERENCE SIGNS LIST

10: Information processing server

20, 20A, 20B: Information processing device

30, 30A, 30B: Terminal device

40, 40A, 40B: User

50: Network

110: Communicating section

120: Group creating section

130: Communication control section

310: Sensor section

320: Action determining section

330: Communicating section

340: Synchronization determining section

350: Sound control section

360: Sound presenting section

1. An information processing device comprising:
an action determining section configured to determine, on a basis of a sensing result of a sensor, an action performed by a user;
a communicating section configured to receive information regarding an action performed by another user;
a synchronization determining section configured to determine temporal coincidence between the action performed by the user and the action performed by the other user; and
a sound control section configured to control, on a basis of the determination of the synchronization determining section, sound presented in correspondence with the actions respectively performed by the user and the other user.

2. The information processing device according to claim 1, wherein
the synchronization determining section determines that the actions of the user and the other user are in synchronism with each other in a case where the action of the user and the action of the other user are performed within a threshold time.

3. The information processing device according to claim 2, wherein
the sound control section changes the presented sound on a basis of whether or not the actions of the user and the other user are in synchronism with each other.

4. The information processing device according to claim 3, wherein
the sound control section controls at least one or more of duration, volume, a pitch, or added sound of the presented sound.

5. The information processing device according to claim 3, wherein,
in a case where the actions of the user and the other user are in synchronism with each other, the sound control section controls the sound such that duration, volume, or a pitch of the presented sound is increased as compared with a case where the actions of the user and the other user are not in synchronism with each other.

6. The information processing device according to claim 5, wherein,
in a case where it is determined that the actions of the user and the other user are in synchronism with each other after sound in a case where the actions of the user and the other user are asynchronous with each other is presented in correspondence with the action of the user, the sound control section controls the sound such that sound in a case where the actions of the user and the other user are in synchronism with each other is presented so as to be superimposed on the sound in the case where the actions of the user and the other user are asynchronous with each other.

7. The information processing device according to claim 1, wherein
the sound presented in correspondence with the action of the other user is decreased in duration, volume, or pitch of the sound as compared with the sound presented in correspondence with the action of the user.

8. The information processing device according to claim 1, wherein
the sensor is included in a wearable device worn by the user.

9. The information processing device according to claim 8, wherein
the sound control section generates the presented sound by modulating sound collected in the wearable device.

10. The information processing device according to claim 1, wherein
the synchronization determining section determines the temporal coincidence between the action performed by the user and the action performed by the other user belonging to a same group as the user.

11. The information processing device according to claim 10, wherein
the group is a group in which users present in a same region, experiencing same content, using a same application, or using a same device are grouped together.

12. The information processing device according to claim 1, wherein
the synchronization determining section determines that the actions of the user and the other user are in synchronism with each other in a case where a difference between a magnitude and a timing of a posture change during the action of the user and a magnitude and a timing of a posture change during the action of the other user is equal to or less than a threshold value.

13. The information processing device according to claim 12, wherein
the synchronization determining section determines a difference in magnitude and timing of movement of at least one or more of an arm, a leg, a head, or a body between the user and the other user.

14. The information processing device according to claim 12, wherein
the sound control section controls a waveform of the presented sound on a basis of a difference between posture changes and timings during the actions of the user and the other user.

15. The information processing device according to claim 14, wherein
the sound control section controls a frequency, an amplitude, or a tone of the presented sound.

16. The information processing device according to claim 14, wherein
the sound control section continuously changes the waveform of the presented sound.

17. An information processing method comprising:
by an arithmetic processing device,
determining, on a basis of a sensing result of a sensor, an action performed by a user;
receiving information regarding an action performed by another user;
determining temporal coincidence between the action performed by the user and the action performed by the other user; and
controlling, on a basis of the determination, sound presented in correspondence with the actions respectively performed by the user and the other user.
